(19) United States
(12) Patent Application Publication
(10) Pub. No.: US 2016/0017688 A1
(43) Pub. Date: Jan. 21, 2016

(54) Encapsulated Fluid-Loss Additives for Cement Compositions

(71) Applicant: Halliburton Energy Services, Inc., Houston, TX (US)

(72) Inventors: Jiten Chatterji, Duncan, OK (US); Darrell Chad Brenneis, Marlow, OK (US); Gregory Robert Hundt, Spring, TX (US)

(73) Assignee: HALLIBURTON ENERGY SERVICES, INC., Houston, TX (US)

(21) Appl. No.: 14/463,521

(22) PCT Filed: Jul. 21, 2014
(86) PCT No.: PCT/US2014/047466

§ 371 Date: Aug. 19, 2014

(51) Int. Cl. E21B 33/13; C09K 8/44; B29C 39/00

(52) U.S. Cl. CPC E21B 33/13; B29C 39/003; C09K 8/44

(57) ABSTRACT

Methods and compositions for cementing in a subterranean formation. An example method of cementing comprises providing a cement composition comprising a hydraulic cement, water, and an encapsulated fluid-loss additive; wherein the encapsulated fluid-loss additive comprises a fluid-loss additive and an encapsulation material; placing the cement composition in a selected location; and allowing the cement composition to set.

### BACKGROUND

Embodiments are directed to encapsulated fluid-loss additives for use in subterranean formations and, in certain embodiments, to cement compositions comprising encapsulated fluid-loss additives and methods of cementing with encapsulated fluid-loss additives in subterranean applications.

Cement compositions may be used in a variety of subterranean applications. For example, cement compositions may be used in primary cementing operations whereby pipe strings, such as casing and liners, may be cemented in wellbores. In a typical primary cementing operation, a cement composition may be pumped into an annulus between the exterior surface of the pipe string disposed therein and the walls of the wellbore (or a larger conduit in the wellbore). The cement composition may set in the annulus, thereby forming an annular sheath of hardened, substantially impermeable material (e.g., a cement sheath) that may support and position the pipe string in the wellbore and may bond the exterior surface of the pipe string to the wellbore walls (or to the larger conduit). Among other things, the cement sheath surrounding the pipe string should function to prevent the migration of fluids in the annulus, as well as protecting the pipe string from corrosion. Cement compositions may also be used in remedial cementing methods, such as in the placement of a cement plug or in squeeze cementing for sealing voids in a pipe string, cement sheath, gravel pack, subterranean formation, and the like.

Fluid-loss additives, e.g., polymers, may be included in a cement composition. Amongst other reasons, fluid-loss additives may be included in a cement composition to control fluid loss to the formation. The fluid loss additive may have a high molecular weight, which can cause an increase in viscosity for the cement composition. Due to the viscosity increase, high pump pressure and rate may be required to place the cement composition into the subterranean formation. With loss of fluid from the cement composition, the cement composition may become too thick for displacement, potentially resulting in formation breakdown and creation of loss circulation zones.

Moreover, the viscosity increase that may be induced by fluid-loss additives may create mixability issues with the cement composition, particularly in situations where the cement components are not fully wetted (e.g., the mixing stage). These issues may necessitate mixing the cement composition more vigorously for longer periods of time. As a result, the cement composition may take longer to prepare, and operation time and cost may be increased.

### BRIEF DESCRIPTION OF THE DRAWINGS

These drawings illustrate certain aspects of some of the embodiments of the present invention, and should not be used to limit or define the invention.

FIG. 1 is a schematic illustration of a system for the preparation and delivery of a cement composition comprising an encapsulated fluid-loss additive to a wellbore in accordance with certain embodiments.

FIG. 2 is a schematic illustration of surface equipment that may be used in the placement of a cement composition comprising an encapsulated fluid-loss additive in a wellbore in accordance with certain embodiments.

FIG. 3 is a schematic illustration of a method of placement of a cement composition comprising an encapsulated fluid-loss additive into a wellbore in accordance with certain embodiments.

FIG. 4 is a schematic illustration of a cement sheath formed from a cement composition comprising an encapsulated fluid-loss additive that was placed into a wellbore annulus in accordance with certain embodiments.

### DESCRIPTION OF PREFERRED EMBODIMENTS

Embodiments are directed to encapsulated fluid-loss additives for use in subterranean formations and, in certain embodiments, to cement compositions comprising encapsulated fluid-loss additives and methods of cementing with encapsulated fluid-loss additives in subterranean applications. In accordance with present embodiments, the “fluid-loss additives” disclosed herein may be referred to as “encapsulated” because an encapsulation material (e.g., a wax) may be included in the fluid-loss additives wherein the encapsulation material allows the delayed release of the fluid-loss additives when mixed with a cement composition. By delaying their release, the fluid-loss additives may increase the viscosity of a cement composition slower relative to unencapsulated fluid-loss additives, and this may result in mixing the cement composition for less time and with less energy. Therefore, because a cement composition comprising an encapsulated fluid-loss additive may have a lower initial viscosity relative to a cement composition comprising an unencapsulated fluid-loss additive, the former cement composition may require less operational time and expense to prepare than the latter cement composition.

Encapsulated fluid-loss additives may be included in a cement composition. Any of the cement compositions disclosed herein may comprise hydraulic cement, an encapsulated fluid-loss additive, and water. Those of ordinary skill in the art will appreciate that embodiments of the cement compositions generally should have a density suitable for a particular application. By way of example, the cement compositions may have a density of about 4 pounds per gallon (“lb/gal”) to about 20 lb/gal. The cement compositions may be foamed or unfoamed or may comprise other means to reduce their densities, such as hollow microspheres, low-density elastic beads, or other density-reducing additives known in the art. The cement compositions may additionally comprise weighting agents to increase their densities. Those of ordinary skill in the art, with the benefit of this disclosure, will recognize the appropriate density for a particular application.

The water used in the cement compositions may include, for example, freshwater, saltwater (e.g., water containing one or more salts dissolved therein), brine (e.g., saturated saltwater produced from subterranean formations), seawater, or any combination thereof. Generally, the water may be from any source, provided that the water does not contain an excess of compounds that may undesirably affect other components in the cement composition. The water may be included in an amount sufficient to form a pumpable slurry. The water may be included in the cement compositions in an amount in the range of from about 40% to about 200% by weight of the hydraulic cement (“bwoc”) and, alternatively, in an amount in a range of from about 40% to about 150% bwoc. By way of further example, the water may be present in an amount ranging between any of and/or including any of about 40%, about 50%, about 60%, about 70%, about 80%, about 90%, about 100%, about 110%, about 120%, about 130%, about 140%, about 150%, about 160%, about 170%, about 180%, about 190%, or about 200% bwoc. One of ordinary skill in the art, with the benefit of this disclosure, should recognize the appropriate amount of the water to include for a chosen application.

Any of a variety of hydraulic cements suitable for use in subterranean cementing operations may be used in accordance with any embodiments of the cement compositions. Suitable examples include hydraulic cements that comprise calcium, aluminum, silicon, oxygen and/or sulfur, which set and harden by reaction with water. Examples of such hydraulic cements, include, but are not limited to, Portland cements, pozzolana cements, gypsum cements, high-alumina-content cements, slag cements, silica cements, and combinations thereof. Suitable Portland cements may be classified as Classes A, C, H, or G cements according to the American Petroleum Institute, API Specification for Materials and Testing for Well Cements, API Specification 10, Fifth Ed., Jul. 1, 1990. In addition, the hydraulic cement may include cements classified as ASTM Type I, II, or III.

An encapsulated fluid-loss additive may be included in any of the embodiments of the cement compositions. The encapsulated fluid-loss additives may comprise a fluid-loss additive (e.g., a polymer) and an encapsulation material. The encapsulated fluid-loss additive may be included in the cement compositions to delay the viscosity increase induced by the fluid-loss additive while mixing the cement compositions. For example, the encapsulated fluid-loss additive may delay the viscosity increase in the cement compositions until the components of the cement compositions become fully wetted, thereby potentially mitigating some of the mixability issues that may be seen in preparation of cement compositions comprising fluid-loss additives.

A wide variety of fluid-loss additives may be encapsulated, including, but not limited to, certain water-soluble polymers (including biopolymers, e.g., polysaccharides), such as hydroxyethyl cellulose, carboxymethylhydroxyethyl cellulose, copolymers of 2-acrylamido-2-methylpropanesulfonic acid and acrylamide or N,N-dimethylacrylamide, and graft copolymers comprising a backbone of lignin or lignite and pendant groups comprising at least one member selected from the group consisting of 2-acrylamido-2-methylpropanesulfonic acid, acrylonitrile, and N,N-dimethylacrylamide; and any such derivatives or combinations thereof. Thus, the fluid-loss additives discussed herein may be defined as polymeric fluid-loss additives. Commercial examples of the fluid-loss additives include HALAD®-9 Fluid-Loss Additive, HALAD®-23 Fluid-Loss Additive, HALAD®-344 Fluid-Loss Additive, and HALAD®-413 Fluid-Loss Additive, available from Halliburton Energy Services, Inc., Houston, Tex. As described above, the type of fluid-loss additives that may benefit from encapsulation are those that function as viscosifiers, including, but not limited to, those fluid-loss additives that may swell when in contact with water. However, a fluid-loss additive need not be a viscosifier to benefit from encapsulation, and this disclosure contemplates the encapsulation of fluid-loss additives that may benefit from a delayed release because they are difficult to mix for reasons other than viscosification or may benefit from a delayed release for reasons which have nothing to do with improving mixability. The fluid-loss additive may be present in the encapsulated fluid-loss additive in an amount of about 50% to about 99.9% by weight of the encapsulated fluid-loss additive. For example, the encapsulation materials may be present in the encapsulated fluid-loss additive in an amount of about 50%, about 60%, about 70%, about 80%, about 90%, or about 99.9% by weight of the encapsulated fluid-loss additive. One of ordinary skill in the art, with the benefit of this disclosure, will be able to select a fluid-loss additive for a particular application.

Encapsulation materials and methods to encapsulate the fluid-loss additives may be used to produce the encapsulated fluid-loss additives. As discussed above, inclusion of an encapsulation material with a fluid-loss additive may mitigate mixability issues induced by the fluid-loss additives. The fluid-loss additive may be encapsulated by the encapsulation material in any sufficient manner. Various types of encapsulation techniques may include, but are not limited to, matrix encapsulation, spray-drying, pan coating, centrifugal extrusion, air-suspension coating, vibrational nozzle encapsulation, and the like. A specific example comprises adding molten encapsulation materials (e.g., wax) to the fluid-loss additives in a blender and then blending the mixture while maintaining a temperature above the melting point of the encapsulation material. The mixture should be blended until a homogenous mixture is formed. In some embodiments, the encapsulation material may be at least partially coated on the fluid-loss additive. In alternative embodiments, the encapsulation material may completely coat the fluid-loss additive. In further alternative embodiments, the encapsulation material may both partially and completely coat the fluid-loss additive. With the benefit of this disclosure, one of ordinary skill in the art will be able to select an encapsulation method suitable for a particular application.

Suitable encapsulation materials may comprise relatively inert materials that do not react or otherwise negatively interfere with the other components of the cement compositions. In some embodiments, the encapsulation materials may be inert to the chemical and physical properties of the cement composition. In some embodiments, these encapsulation materials should cause no significant changes in the conventional, desirable cement properties of the cement compositions. Such properties may include density, rheology, pumping time, fluid loss, static gel strength, permeability, gas migration, compressive strength, thickening time, etc.

Encapsulation materials may comprise any material capable of encapsulating the fluid-loss additives. Example embodiments may comprise water-insoluble polymers such as acrylic acid cross-linked with polyalkenyl ethers or divinyl glycol and waxes such as polyethylene wax, stearamide wax, paraffin wax, and the like. A commercial example of a suitable encapsulation material is the Carbopol® family of polymers, a registered trademark of Noveon, Inc. Another commercial example of an encapsulation material is BW-436 paraffin wax, available from Blended Waxes, Inc. of Oshkosh, Wis. The melting point of the encapsulation material may be a factor for consideration in choosing an encapsulation material. The melting point may, in some instances, determine the rate of release of the fluid-loss additive from the encapsulation material. However, this property need not be controlling of the rate of fluid-loss release as is noted in Example 2 below. Without being limited by theory, it is believed that abrasion of the encapsulating layer may occur as the encapsulation material that encapsulates the fluid-loss additive contacts other materials in the cement composition. The encapsulation materials used in any of the embodiments of the cement compositions may comprise any melting point sufficient for an application. Additional melting point considerations may include storage of the fluid-loss additives in high-heat environments, wherein it may be advantageous to select encapsulation materials that can be stored on site without melting and/or compaction. With the benefit of this disclosure, one of ordinary skill in the art will be able to select an encapsulation material suitable for a particular application.

The amount of the encapsulation material used in embodiments generally may depend on a number of factors, which may include the particular fluid-loss additive, the particular encapsulation material, encapsulation technique desired, melting point of the encapsulation material, and cost among others. The encapsulation material may be present in the encapsulated fluid-loss additive in an amount of about 0.1% to about 50% by weight of the encapsulated fluid-loss additive. For example, the encapsulation material may be present in the encapsulated fluid-loss additive in an amount of about 0.1%, about 2.5%, about 5%, about 10%, about 20%, about 30%, about 40%, or about 50% by weight of the encapsulated fluid-loss additive. One or ordinary skill in the art, with the benefit of this disclosure, should be able to select an appropriate amount of an encapsulation material to use for a particular application.

The encapsulated fluid-loss additives may be added to embodiments of the cement compositions by dry blending with the hydraulic cement before the addition of the water, by mixing with the water to be added to the hydraulic cement, or by mixing with the cement composition consecutively with or after the addition of the water. Moreover, the encapsulated fluid-loss additives may be included in embodiments of the cement compositions in an amount desired for a particular application. In some embodiments, the encapsulated fluid-loss additives may be present in a cement composition in an amount of about 0.1% to about 4% bwoc. For example, the encapsulated fluid-loss additive may be present in a cement composition in an amount of about 0.1%, about 0.5%, about 1%, about 2%, about 3%, or about 4% bwoc. One of ordinary skill in the art, with the benefit of this disclosure, will be able to select an amount of encapsulated fluid-loss additive for a particular application.

Generally, the encapsulation materials may delay the release of the fluid-loss additives for a time sufficient to mix the cement compositions. The encapsulation materials may delay the release for a time of about 5 minutes to about 30 minutes. However, the length of the delay will be due to a variety of factors, including the type of cement composition desired, the type of encapsulation materials, the temperature of the conditions including both at the surface and downhole, etc. For most applications, it will be desirable to delay release of the fluid-loss additives at least until the cement slurry is completely wet and either ready to be pumped downhole or already being pumped downhole. One of ordinary skill in the art, with the benefit of this disclosure, will be able to select a length of time to delay the release of the fluid-loss additives.

Additionally, the encapsulated fluid-loss additives may have a particle size in the range of about 5 microns to about 1,500 microns. In some embodiments, the encapsulated fluid-loss additives may have a particle size in the range of about 20 microns to about 500 microns. However, particle sizes outside these disclosed ranges may also be suitable for particular applications.

Other additives suitable for use in subterranean cementing operations also may be added to embodiments of the cement compositions as deemed appropriate by one of ordinary skill in the art. Examples of such additives include, but are not limited to, strength-retrogression additives, set accelerators, set retarders, weighting agents, lightweight additives, gas-generating additives, mechanical property enhancing additives, lost-circulation materials, dispersants, defoaming agents, foaming agents, thixotropic additives, and combinations thereof. Specific examples of these, and other, additives include silica (e.g., crystalline silica, amorphous silica, fumed silica, etc.), salts, fibers, hydratable clays, shale (e.g., calcined shale, vitrified shale, etc.), microspheres, diatomaceous earth, natural pozzolan, resins, latex, combinations thereof, and the like. Other optional additives may also be included, including, but not limited to, cement kiln dust, lime kiln dust, fly ash, slag cement, shale, zeolite, metakaolin, pumice, perlite, lime, silica, rice husk ash, small-particle size cement, combinations thereof, and the like. A person having ordinary skill in the art, with the benefit of this disclosure, will readily be able to determine the type and amount of additive useful for a particular application and desired result.

Strength-retrogression additives may be included in embodiments of the cement composition to, for example, prevent the retrogression of strength after the cement composition has been allowed to develop compressive strength when the cement composition is exposed to high temperatures. These additives may allow the cement compositions to form as intended, preventing cracks and premature failure of the cementitious composition. Examples of suitable strength-retrogression additives may include, but are not limited to, amorphous silica, coarse grain crystalline silica, fine grain crystalline silica, or a combination thereof.

Set accelerators may be included in embodiments of the cement compositions to, for example, increase the rate of setting reactions. Control of setting time may allow for the ability to adjust to wellbore conditions or customize set times for individual jobs. Examples of suitable set accelerators may include, but are not limited to, aluminum sulfate, alums, calcium chloride, calcium sulfate, gypsum-hemihydrate, sodium aluminate, sodium carbonate, sodium chloride, sodium silicate, sodium sulfate, ferric chloride, or a combination thereof.

Set retarders may be included in embodiments of the cement compositions to, for example, increase the thickening time of the cement compositions. Examples of suitable set retarders include, but are not limited to, ammonium, alkali metals, alkaline earth metals, borax, metal salts of calcium lignosulfonate, carboxymethyl hydroxyethyl cellulose, sulfoalkylated lignins, hydroxycarboxy acids, copolymers of 2-acrylamido-2-methylpropane sulfonic acid salt and acrylic acid or maleic acid, saturated salt, or a combination thereof. One example of a suitable sulfoalkylated lignin comprises a sulfomethylated lignin.

Weighting agents are typically materials that weigh more than water and may be used to increase the density of a cement composition. By way of example, weighting agents may have a specific gravity of about 2 or higher (e.g., about 2, about 4, etc.). Examples of weighting agents that may be used include, but are not limited to, hematite, hausmannite, and barite, and combinations thereof. Specific examples of suitable weighting agents include HI-DENSE® weighting agent, available from Halliburton Energy Services, Inc.

Lightweight additives may be included in embodiments of the cement compositions to, for example, decrease the density of the cement compositions. Examples of suitable lightweight additives include, but are not limited to, bentonite, coal, diatomaceous earth, expanded perlite, fly ash, gilsonite, hollow microspheres, low-density elastic beads, nitrogen, pozzolan-bentonite, sodium silicate, combinations thereof, or other lightweight additives known in the art.

Gas-generating additives may be included in embodiments of the cement compositions to release gas at a predetermined time, which may be beneficial to prevent gas migration from the formation through the cement composition before it hardens. The generated gas may combine with or inhibit the permeation of the cement composition by formation gas. Examples of suitable gas-generating additives include, but are not limited to, metal particles (e.g., aluminum powder) that react with an alkaline solution to generate a gas.

Mechanical-property-enhancing additives may be included in embodiments of the cement compositions to, for example, ensure adequate compressive strength and long-term structural integrity. These properties can be affected by the strains, stresses, temperature, pressure, and impact effects from a subterranean environment. Examples of mechanical property enhancing additives include, but are not limited to, carbon fibers, glass fibers, metal fibers, mineral fibers, silica fibers, polymeric elastomers, and latexes.

Lost-circulation materials may be included in embodiments of the cement compositions to, for example, help prevent the loss of fluid circulation into the subterranean formation. Examples of lost-circulation materials include but are not limited to, cedar bark, shredded cane stalks, mineral fiber, mica flakes, cellophane, calcium carbonate, ground rubber, polymeric materials, pieces of plastic, grounded marble, wood, nut hulls, formica, corncobs, and cotton hulls.

Dispersants may be included in embodiments of the cement compositions. Where present, the dispersant should act, among other things, to control the rheology of the cement composition. While a variety of dispersants known to those skilled in the art may be used in certain embodiments, examples of suitable dispersants include naphthalene sulfonic acid condensate with formaldehyde; acetone, formaldehyde, and sulfite condensate; melamine sulfonate condensed with formaldehyde; any combination thereof.

Defoaming additives may be included in embodiments of the cement compositions to, for example, reduce tendency for the cement composition to foam during mixing and pumping of the cement compositions. Examples of suitable defoaming additives include, but are not limited to, polyol silicone compounds. Suitable defoaming additives are available from Halliburton Energy Services, Inc., under the product name D-AIR™ defoamers.

Foaming additives (e.g., foaming surfactants) may be included in embodiments to, for example, facilitate foaming and/or stabilize the resultant foam formed therewith. Examples of suitable foaming additives include, but are not limited to: mixtures of an ammonium salt of an alkyl ether sulfate, a cocoamidopropyl betaine surfactant, a cocoamidopropyl dimethylamine oxide surfactant, sodium chloride, and water; mixtures of an ammonium salt of an alkyl ether sulfate surfactant, a cocoamidopropyl hydroxysultaine surfactant, a cocoamidopropyl dimethylamine oxide surfactant, sodium chloride, and water; hydrolyzed keratin; mixtures of an ethoxylated alcohol ether sulfate surfactant, an alkyl or alkene amidopropyl betaine surfactant, and an alkyl or alkene dimethylamine oxide surfactant; aqueous solutions of an alpha-olefinic sulfonate surfactant and a betaine surfactant; and combinations thereof. An example of a suitable foaming additive is ZONESEALANT™ 2000 agent, available from Halliburton Energy Services, Houston, Tex.

Thixotropic additives may be included in embodiments of the cement compositions to, for example, provide a cement composition that can be pumpable as a thin or low viscosity fluid, but when allowed to remain quiescent attains a relatively high viscosity. Among other things, thixotropic additives may be used to help control free water, create rapid gelation as the slurry sets, combat lost circulation, prevent “fallback” in annular column, and minimize gas migration. Examples of suitable thixotropic additives include, but are not limited to, gypsum, water soluble carboxyalkyl, hydroxyalkyl, mixed carboxyalkyl hydroxyalkyl either of cellulose, polyvalent metal salts, zirconium oxychloride with hydroxyethyl cellulose, or a combination thereof.

Any of the cement compositions may comprise hydraulic cement, an encapsulated fluid-loss additive, and water and may be used in any of a variety of cementing applications. For example, a method may comprise providing a cement composition comprising hydraulic cement, an encapsulated fluid-loss additive, and water; and allowing the cement composition to set. As described above, the encapsulated fluid-loss additive may comprise a fluid-loss additive and an encapsulation material. As will be appreciated by those in the art, the cement compositions may be allowed to set in any suitable location where it may be desired for the cement composition to set into a hardened mass. By way of example, the cement compositions may be allowed to set in a variety of locations, both above and below ground.

Additionally, the cement compositions may be used in a variety of subterranean operations, including primary and remedial cementing. For example, a cement composition may be provided that comprises hydraulic cement, an encapsulated fluid-loss additive, and water. The cement composition may be introduced into a subterranean formation and allowed to set therein. As used herein, introducing a cement composition into a subterranean formation includes introduction into any portion of the subterranean formation, including, without limitation, into a wellbore drilled into the subterranean formation, into a near wellbore region surrounding the wellbore, or into both.

In primary cementing embodiments, for example, a cement composition may be introduced into an annular space between a conduit located in a wellbore and the walls of a wellbore (and/or a larger conduit in the wellbore), wherein the wellbore penetrates a subterranean formation. The cement composition may be allowed to set in the annular space to form an annular sheath of hardened cement. The cement composition may form a barrier that prevents the migration of fluids in the wellbore. The cement composition may also, for example, support the conduit in the wellbore.

In remedial cementing embodiments, a cement composition may be used, for example, in squeeze-cementing operations or in the placement of cement plugs. By way of example, the cement composition may be placed in a wellbore to plug an opening (e.g., a void or crack) in the formation, in a gravel pack, in the conduit, in the cement sheath, and/or between the cement sheath and the conduit (e.g., a microannulus).

A method of cementing may comprise providing a cement composition comprising a hydraulic cement, water, and an encapsulated fluid-loss additive; wherein the encapsulated fluid-loss additive comprises a fluid-loss additive and an encapsulation material; placing the cement composition in a selected location; and allowing the cement composition to set. The cement composition may have a density in a range of from about 4 pounds per gallon to about 20 pounds per gallon, and the water may be present in an amount sufficient to form a pumpable slurry. The hydraulic cement may comprise at least one hydraulic cement selected from the group consisting of Portland cement, pozzolana cement, gypsum cement, high-alumina-content cement, slag cement, silica cement, and any combination thereof. The fluid-loss additive may comprise a water-soluble polymer selected from the group consisting of hydroxyethyl cellulose, carboxymethylhydroxyethyl cellulose, copolymers of 2-acrylamido-2-methylpropanesulfonic acid and acrylamide or N,N-dimethylacrylamide, graft copolymers comprising a backbone of lignin or lignite and pendant groups comprising at least one member selected from the group consisting of 2-acrylamido-2-methylpropanesulfonic acid, acrylonitrile, and N,N-dimethylacrylamide; xanthan gum, and any combination thereof. The encapsulated fluid-loss additive may be present in the cement composition in an amount of about 0.1% to about 4% by weight of the cement composition. The encapsulation material may be selected from the group consisting of paraffin wax, polyethylene wax, stearamide wax, and any combination thereof. The encapsulation material may be present in the encapsulated fluid loss additive in an amount of about 0.1% to about 50% by weight of the encapsulated fluid loss additive. The fluid-loss additive may be present in the encapsulated fluid-loss additive in an amount of about 50% to about 99.9% by weight of the encapsulated fluid-loss additive. The fluid-loss additive may be encapsulated with the encapsulation material using matrix-encapsulation. The cement composition may be used in a primary cementing operation. The cement composition may be introduced into a wellbore in a subterranean formation.

A cement composition may comprise a hydraulic cement, water, and an encapsulated fluid-loss additive; wherein the encapsulated fluid-loss additive comprises a fluid-loss additive and an encapsulation material. The cement composition may have a density in a range of from about 4 pounds per gallon to about 20 pounds per gallon, and the water may be present in an amount sufficient to form a pumpable slurry. The hydraulic cement may comprise at least one hydraulic cement selected from the group consisting of Portland cement, pozzolana cement, gypsum cement, high-alumina-content cement, slag cement, silica cement, and any combination thereof. The fluid-loss additive may comprise a water-soluble polymer selected from the group consisting of hydroxyethyl cellulose, carboxymethylhydroxyethyl cellulose, copolymers of 2-acrylamido-2-methylpropanesulfonic acid and acrylamide or N,N-dimethylacrylamide, graft copolymers comprising a backbone of lignin or lignite and pendant groups comprising at least one member selected from the group consisting of 2-acrylamido-2-methylpropanesulfonic acid, acrylonitrile, and N,N-dimethylacrylamide; xanthan gum, and any combination thereof. The encapsulated fluid-loss additive may be present in the cement composition in an amount of about 0.1% to about 4% by weight of the cement composition. The encapsulation material may be selected from the group consisting of paraffin wax, polyethylene wax, stearamide wax, and any combination thereof. The encapsulation material may be present in the encapsulated fluid loss additive in an amount of about 0.1% to about 50% by weight of the encapsulated fluid loss additive. The fluid-loss additive may be present in the encapsulated fluid-loss additive in an amount of about 50% to about 99.9% by weight of the encapsulated fluid-loss additive. The fluid-loss additive may be encapsulated with the encapsulation material using matrix-encapsulation.

A cementing system may comprise a cement composition comprising: a hydraulic cement, water, and an encapsulated fluid-loss additive; wherein the encapsulated fluid-loss additive comprises a fluid-loss additive and an encapsulation material; mixing equipment capable of mixing the cement composition; and pumping equipment capable of delivering the cement composition into a wellbore. The cement composition may have a density in a range of from about 4 pounds per gallon to about 20 pounds per gallon, and the water may be present in an amount sufficient to form a pumpable slurry. The hydraulic cement may comprise at least one hydraulic cement selected from the group consisting of Portland cement, pozzolana cement, gypsum cement, high-alumina-content cement, slag cement, silica cement, and any combination thereof. The fluid-loss additive may comprise a water-soluble polymer selected from the group consisting of hydroxyethyl cellulose, carboxymethylhydroxyethyl cellulose, copolymers of 2-acrylamido-2-methyl propanesulfonic acid and acrylamide or N,N-dimethylacrylamide, graft copolymers comprising a backbone of lignin or lignite and pendant groups comprising at least one member selected from the group consisting of 2-acrylamido-2-methylpropanesulfonic acid, acrylonitrile, and N,N-dimethylacrylamide; and any combination thereof. The encapsulated fluid-loss additive may be present in the cement composition in an amount of about 0.1% to about 4% by weight of the cement composition. The encapsulation material may be selected from the group consisting of paraffin wax, polyethylene wax, stearamide wax, and any combination thereof. The encapsulation material may be present in the encapsulated fluid loss additive in an amount of about 0.1% to about 50% by weight of the encapsulated fluid loss additive. The fluid-loss additive may be present in the encapsulated fluid-loss additive in an amount of about 50% to about 99.9% by weight of the encapsulated fluid-loss additive. The fluid-loss additive may be encapsulated with the encapsulation material using matrix-encapsulation.

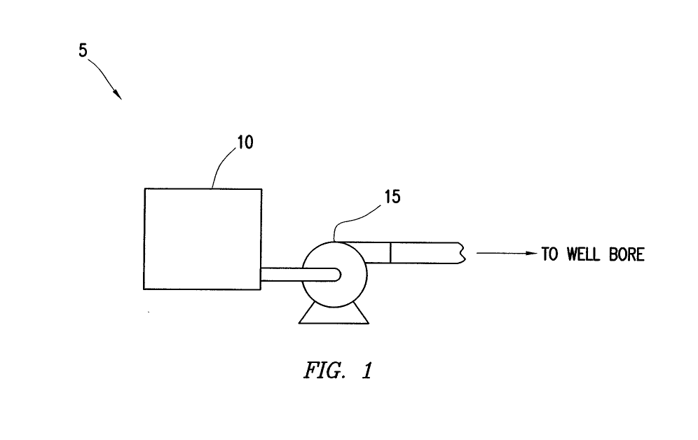

Example methods of using cement compositions comprising encapsulated fluid-loss additives will now be described in more detail with reference to FIGS. 1-4. FIG. 1 illustrates a system 5 for preparation of a cement composition comprising hydraulic cement, an encapsulated fluid-loss additive, and water and delivery of the cement composition to a wellbore in accordance with certain embodiments. As shown, the cement composition may be mixed in mixing equipment 10, such as a jet mixer, re-circulating mixer, or a batch mixer, for example, and then pumped via pumping equipment 15 to the wellbore. In some embodiments, the mixing equipment 10 and the pumping equipment 15 may be disposed on one or more cement trucks as will be apparent to those of ordinary skill in the art. In some embodiments, a jet mixer may be used, for example, to continuously mix a dry blend comprising the hydraulic cement and one or more encapsulated fluid-loss additives with the water as it is being pumped to the wellbore.

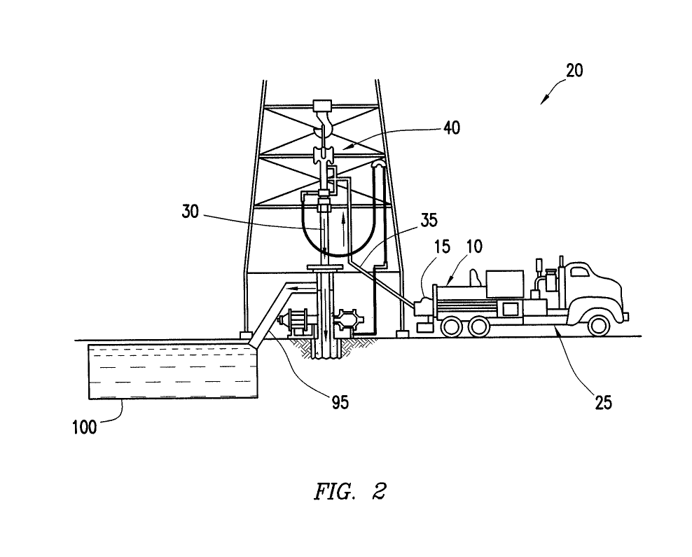

An example technique for placing a cement composition comprising an encapsulated fluid-loss additive into a subterranean formation will now be described with reference to FIGS. 2-4. FIG. 2 illustrates surface equipment 20 that may be used in the placement of the cement composition in accordance with certain embodiments. It should be noted that while FIG. 2 generally depicts a land-based operation, those skilled in the art will readily recognize that the principles described herein are equally applicable to subsea operations that employ floating or sea-based platforms and rigs, without departing from the scope of the disclosure. As illustrated by FIG. 2, the surface equipment 20 may include a cementing unit 25, which may include one or more cement trucks. The cementing unit 25 may include mixing equipment 10 and pumping equipment 15 (e.g., as illustrated by FIG. 1) as will be apparent to those of ordinary skill in the art. The cementing unit 25 may pump a cement composition 30, which comprises hydraulic cement, an encapsulated fluid-loss additive, and water, through a feed pipe 35 and to a cementing head 40 which conveys the cement composition 30 downhole.

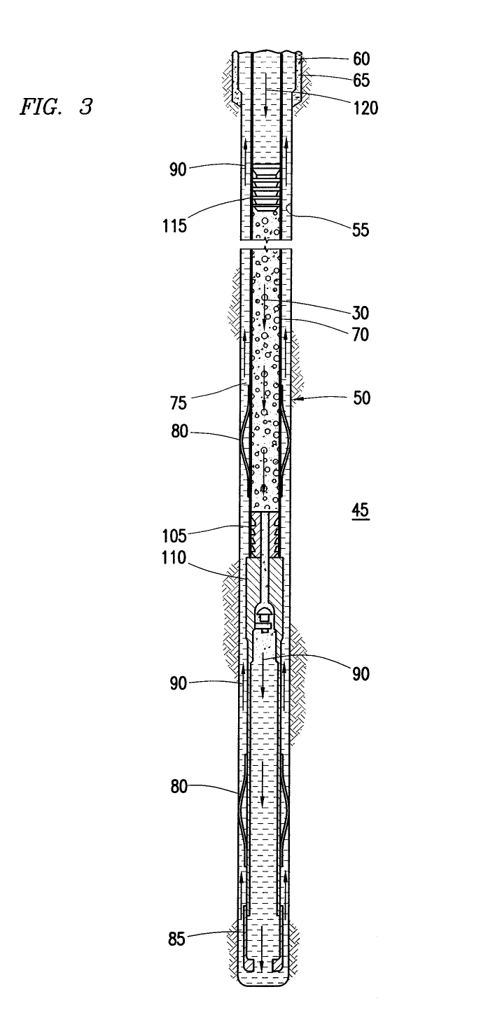

Turning now to FIG. 3, the cement composition 30, which comprises the encapsulated fluid-loss additive, may be placed into a subterranean formation 45 in accordance with any of the embodiments. As illustrated, a wellbore 50 may be drilled into one or more subterranean formations 45. While the wellbore 50 is shown generally extending vertically into subterranean formation 45, the principles described herein are also applicable to wellbores that extend at an angle through subterranean formation 45, such as horizontal and slanted wellbores. As illustrated, the wellbore 50 comprises walls 55. A surface casing 60 has been inserted into the wellbore 50. The surface casing 60 may be cemented to the walls 55 of the wellbore 50 by a first cement sheath 65. In the illustrated embodiment, one or more additional conduits (e.g., intermediate casing, production casing, liners, etc.), shown here as casing 70 may also be disposed in the wellbore 50. As illustrated, there is a wellbore annulus 75 formed between the casing 70 and the walls 55 of the wellbore 50 and/or the surface casing 60. One or more centralizers 80 may be attached to the casing 70, for example, to centralize the casing 70 in the wellbore 50 prior to and during the cementing operation.

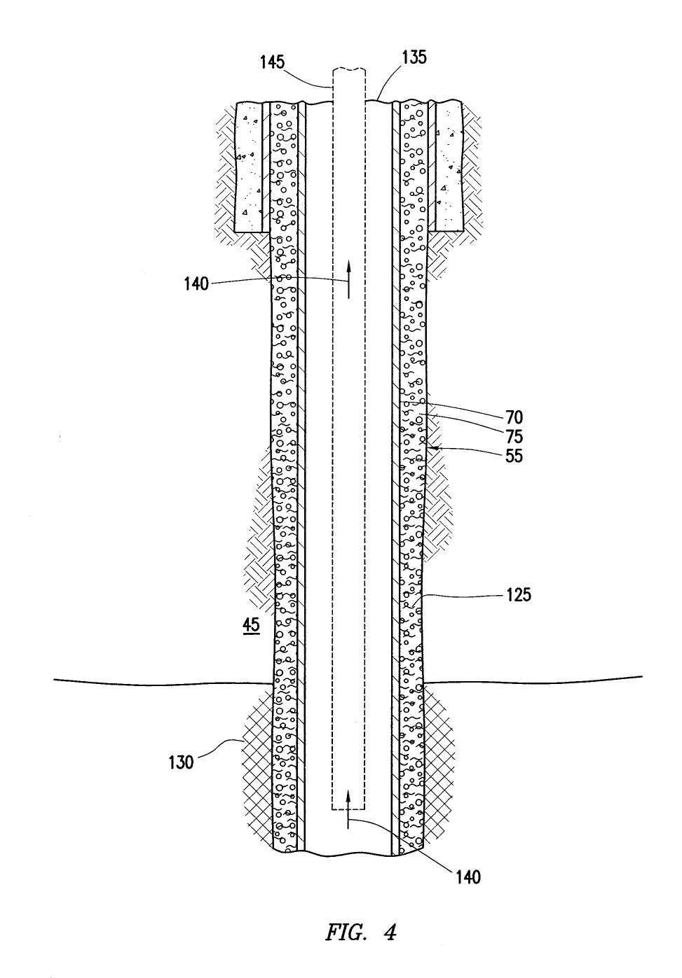

With continued reference to FIG. 3, the cement composition 30 may be pumped down the interior of the casing 70. The cement composition 30 may be allowed to flow down the interior of the casing 70 through the casing shoe 85 at the bottom of the casing 70 and up around the casing 70 into the wellbore annulus 75. The cement composition 30 may be allowed to set in the wellbore annulus 75, for example, to form a second cement sheath 125 (e.g., second cement sheath 125 on FIG. 4) that supports and positions the casing 70 in the wellbore 50. Inclusion of the encapsulated fluid-loss additive in the cement composition 30 should prevent and/or reduce flow of the aqueous phase of the cement composition 30 into the subterranean formation 45 through filtration. While not illustrated, other techniques may also be utilized for introduction of the cement composition 30. By way of example, reverse circulation techniques may be used that include introducing the cement composition 30 into the subterranean formation 45 by way of the wellbore annulus 75 instead of through the casing 70.

As it is introduced, the cement composition 30 may displace other fluids 90, such as drilling fluids and/or spacer fluids that may be present in the interior of the casing 70 and/or the wellbore annulus 75. At least a portion of the displaced fluids 90 may exit the wellbore annulus 75 via a flow line 95 and be deposited, for example, in one or more retention pits 100 (e.g., a mud pit, as illustrated on FIG. 2). Referring again to FIG. 3, a bottom plug 105 may be introduced into the wellbore 55 ahead of the cement composition 30, for example, to separate the cement composition 30 from the other fluids 90 that may be inside the casing 70 prior to cementing. After the bottom plug 105 reaches the landing collar 110, a diaphragm or other suitable device should rupture to allow the cement composition 30 through the bottom plug 105. In FIG. 3, the bottom plug 105 is shown on the landing collar 110. In the illustrated embodiment, a top plug 115 may be introduced into the wellbore 55 behind the cement composition 30. The top plug 115 may separate the cement composition 30 from a displacement fluid 120 and also push the cement composition 30 through the bottom plug 105.

Referring now to FIG. 4, the second cement sheath 125 formed by cement composition 30 (e.g., cement composition 30 illustrated in FIG. 3) is shown. As illustrated, the cement sheath 125 is formed in the wellbore annulus 75. Hydrocarbons may then flow from a producing zone 130 of the one or more subterranean formations 45 up through the casing 70 and to a surface 135, as illustrated by arrows 140. Production tubing 145 may be disposed in the casing 70 to produce a conduit for passage of the hydrocarbons. The preceding description provides various embodiments of cementing with a cement composition comprising an encapsulated fluid-loss additive which may contain any of the different additives disclosed herein in any concentrations thereof. It should be understood that, although individual embodiments may be discussed herein, the present disclosure covers all combinations of the disclosed embodiments, including, without limitation, the different additive combinations, additive concentrations, and composition properties.

The exemplary encapsulated fluid-loss additive disclosed herein may directly or indirectly affect one or more components or pieces of equipment associated with the preparation, delivery, recapture, recycling, reuse, and/or disposal of the disclosed encapsulated fluid-loss additive. For example, the encapsulated fluid-loss additive may directly or indirectly affect one or more mixers, related mixing equipment, mud pits, storage facilities or units, composition separators, heat exchangers, sensors, gauges, pumps, compressors, and the like used generate, store, monitor, regulate, and/or recondition the encapsulated fluid-loss additive and fluids containing the same. The disclosed encapsulated fluid-loss additive may also directly or indirectly affect any transport or delivery equipment used to convey the encapsulated fluid-loss additive to a well site or downhole such as, for example, any transport vessels, conduits, pipelines, trucks, tubulars, and/or pipes used to compositionally move the encapsulated fluid-loss additive from one location to another, any pumps, compressors, or motors (e.g., topside or downhole) used to drive the encapsulated fluid-loss additive, or fluids containing the same, into motion, any valves or related joints used to regulate the pressure or flow rate of the encapsulated fluid-loss additive (or fluids containing the same), and any sensors (i.e., pressure and temperature), gauges, and/or combinations thereof, and the like. The disclosed encapsulated fluid-loss additive may also directly or indirectly affect the various downhole equipment and tools that may come into contact with the encapsulated fluid-loss additive such as, but not limited to, wellbore casing, wellbore liner, completion string, insert strings, drill string, coiled tubing, slickline, wireline, drill pipe, drill collars, mud motors, downhole motors and/or pumps, cement pumps, surface-mounted motors and/or pumps, centralizers, turbolizers, scratchers, floats (e.g., shoes, collars, valves, etc.), logging tools and related telemetry equipment, actuators (e.g., electromechanical devices, hydromechanical devices, etc.), sliding sleeves, production sleeves, plugs, screens, filters, flow control devices (e.g., inflow control devices, autonomous inflow control devices, outflow control devices, etc.), couplings (e.g., electro-hydraulic wet connect, dry connect, inductive coupler, etc.), control lines (e.g., electrical, fiber optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like.

### EXAMPLES

To facilitate a better understanding of the disclosed embodiments, the following examples of some of the embodiments are given. In no way should such examples be read to limit, or to define, the scope of the disclosure.

### Example 1

Sample cement compositions were prepared to evaluate the degree of fluid loss mitigation provided by an encapsulated fluid-loss additive. Each sample contained 600 g of Class H Portland cement and 270.64 g (45% bwoc) of water. Each sample had a density of 15.8 lb/gal. Sample 1 contained 3.6 g of a copolymer of 2-acrylamido-2-methylpropanesulfonic acid and N,N-dimethylacrylamide which is an unencapusulated fluid-loss additive. Sample 2 contained 4.5 g (0.6% active fluid-loss additive bwoc) of a copolymer of 2-acrylamido-2-methylpropanesulfonic acid and N,N-dimethylacrylamide fluid-loss additive which was encapsulated with paraffin wax by a matrix-encapsulation technique. The paraffin wax was BW-436 paraffin wax, available from Blended Waxes, Inc. of Oshkosh, Wis., and it has a melting point of 149° F. to 151° F. Sample 3 did not contain a fluid loss additive and was used as the control. Each sample was conditioned at 125° F. for 30 minutes and fluid loss was measured at 125° F. and 1000 psi in accordance with API Recommended Practices 10B-2.

TABLE 1
Fluid Loss Measurements

| | Unencapsu- | Encapsu- | Initial | Final | |
|---|---|---|---|---|---|
| | lated | lated | Bc | Bc | Fluid Loss |
| Sample 1 | 3.6 g | — | 4 | 4 | 44 mL |
| Sample 2 | — | 4.5 g | 3 | 3 | 46 mL |
| Sample 3 | — | — | 4 | 4 | 880 mL |

The results indicate that there is little difference in the fluid loss of the cement compositions by using an encapsulated fluid-loss additive as compared to an unencapsulated fluid-loss additive.

### Example 2

Sample 2 from Example 1 above was use to evaluate the rheological properties of a cement composition containing an encapsulated fluid-loss additive. The rheology was measured using a Fann Model 35 Viscometer. Dial readings were recorded at speeds of 3, 6, 100, 200, and 300 with a B1 bob, an RI rotor, and a 1.0 spring. The dial readings for the cement composition were measured in accordance with API Recommended Practices 10B, Bingham plastic model. The sample was conditioned at room temperature (75° F.), and fluid loss measurements were tested as room temperature (75° F.) and at 1000 psi in accordance with API Recommended Practices 10B-2. Sample 1 from Example 1 was also evaluated as a comparative sample at 30 minutes of conditioning time under the same conditions as Sample 2.

TABLE 2
Rheology Measurements

| | Conditioning | Fluid Loss | Viscometer RPM | | | | |
|---|---|---|---|---|---|---|---|
| | Time (min.) | (mL) | 3 | 6 | 100 | 200 | 300 |
| Encapsulated | 0 | — | 1 | 4 | 31 | 58 | 82 |
| Encapsulated | 30 | 36 | 1 | 6 | 38 | 73 | 106 |
| Encapsulated | 60 | 34 | 3 | 7 | 40 | 72 | 103 |
| Encapsulated | 120 | 32 | 3 | 8 | 39 | 77 | 113 |
| Unencapsulated | 30 | 32 | 2 | 9 | 57 | 100 | 138 |

The results indicate that the viscosity increases and the fluid loss decreases over time which may indicate that the fluid-loss additive is being released from its encapsulation. Furthermore, the results illustrate that the fluid-loss additive may still be released at temperatures lower than the melting point of the encapsulation material.

### Example 3

Sample cement compositions were prepared to evaluate the thickening times of encapsulated fluid-loss additives versus unencapsulated fluid loss additives. Each sample contained 800 g of Class H Portland cement, 315.37 g (39.4% bwoc) of water, and 1.6 g (0.2% bwoc) of lignosulfonate cement retarder. Each sample also had a density of 16.4 lb/gal. The unencapsulated fluid-loss additive was a copolymer of 2-acrylamido-2-methylpropanesulfonic acid and N,N-dimethylacrylamide and was present in the first sample in an amount of 4.8 g. The encapsulated fluid-loss additive was a copolymer of 2-acrylamido-2-methylpropanesulfonic acid and N,N-dimethylacrylamide fluid-loss additive which was encapsulated with paraffin wax by a matrix-encapsulation technique and was present in the second sample in an amount of 6 g (0.6% active fluid-loss additive bwoc). The paraffin wax was BW-436 paraffin wax, available from Blended Waxes, Inc. of Oshkosh, Wis., and it has a melting point of 149° F. to 151° F. After blending, the thickening times of each cement composition was measured using a high-pressure, high-temperature consistometer where the mixtures were heated to 125° F. at a pressure of 5200 psi for 28 minutes. The thickening times were the times for the cement composition to reach 70 Bc and were measured in accordance with API RP 10B-2. The results are presented in Table 3 below.

TABLE 3
Thickening Time Measurements

| Fluid Loss Agent | Thickening Time (hr:min) |
|---|---|
| Unencapsulated | 4:51 |
| Encapsulated | 4:37 |

The results indicate that there is no significant difference in the thickening times of the cement compositions by using an encapsulated fluid-loss additive as compared to an unencapsulated fluid-loss additive.

### Example 4

Samples 1 and 2 from Example 1 above were used to evaluate the effect on compressive strength of encapsulated fluid-loss additives versus unencapsulated fluid loss additives. The Samples were poured into 1-inch by 2-inch brass cylinders and cured in a water bath at 150° F. for 48 hours. Immediately after removal from the water bath, destructive compressive strengths were determined using a Tinius Olsen mechanical press in accordance with API RP 10B-2. The results of this test are set forth in Table 4 below.

TABLE 4
Compressive Strength Measurements

| | | | Compressive Strength |
|---|---|---|---|
| | Unencapsulated | Encapsulated | (psi) |
| Sample 1 | 3.6 g | — | 3375 |
| Sample 2 | — | 4.5 g | 5680 |

The results indicate that the cement composition containing the encapsulated fluid-loss additive is capable of building significant compressive strength and does not negatively affect the compressive strength of the cement composition.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Although individual embodiments are discussed, the invention covers all combinations of all those embodiments. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative embodiments disclosed above may be altered or modified and all such variations are considered within the scope and spirit of the present invention. If there is any conflict in the usages of a word or term in this specification and one or more patent(s) or other documents that may be incorporated herein by reference, the definitions that are consistent with this specification should be adopted.

1. A method of cementing comprising:
providing a cement composition comprising:
a hydraulic cement,
water, and
an encapsulated fluid-loss additive; wherein the encapsulated fluid-loss additive comprises a fluid-loss additive in an amount of about 60% to about 99.9% by weight of the encapsulated fluid-loss additive and an encapsulation material in an amount of about 0.1% to about 40% by weight of the encapsulated fluid-loss additive; wherein the fluid-loss additive is encapsulated by matrix encapsulation;
placing the cement composition in a selected location; and
allowing the cement composition to set;
wherein the encapsulation material delays release of the fluid-loss additive into the cement composition for a time of about 5 minutes to about 30 minutes.

2. The method of claim 1 wherein the cement composition has a density in a range of from about 4 pounds per gallon to about 20 pounds per gallon, and wherein the water is present in an amount sufficient to form a pumpable slurry.

3. The method of claim 1 wherein the hydraulic cement comprises at least one hydraulic cement selected from the group consisting of Portland cement, pozzolana cement, gypsum cement, high-alumina-content cement, slag cement, silica cement, and any combination thereof.

4. The method of claim 1 wherein the fluid-loss additive comprises a water-soluble polymer selected from the group consisting of hydroxyethyl cellulose, carboxymethylhydroxyethyl cellulose, copolymers of 2-acrylamido-2-methylpropanesulfonic acid and acrylamide or N,N-dimethylacrylamide, graft copolymers comprising a backbone of lignin or lignite and pendant groups comprising at least one member selected from the group consisting of 2-acrylamido-2-methylpropanesulfonic acid, acrylonitrile, and N,N-dimethylacrylamide; and any combination thereof.

5. The method of claim 1 wherein the encapsulated fluid-loss additive is present in the cement composition in an amount of about 0.1% to about 4% by weight of the cement composition.

6. The method of claim 1 wherein the encapsulation material is selected from the group consisting of paraffin wax, polyethylene wax, stearamide wax, and any combination thereof.

7. The method of claim 1 wherein the encapsulation material is present in the encapsulated fluid-loss additive in an amount of about 0.1% to about 20% by weight of the encapsulated fluid-loss additive.

8. The method of claim 1 wherein the fluid-loss additive is present in the encapsulated fluid-loss additive in an amount of about 80% to about 99.9% by weight of the encapsulated fluid-loss additive.

9. (canceled)

10. The method of claim 1 wherein the cement composition is used in a primary cementing operation.

11. The method of claim 1 wherein the selected location is in a well bore in a subterranean formation.

12.-18. (canceled)

19. A cementing system comprising:
a cement composition comprising:
a hydraulic cement,
water, and
an encapsulated fluid-loss additive; wherein the encapsulated fluid-loss additive comprises a fluid-loss additive in an amount of about 60% to about 99.9% by weight of the encapsulated fluid-loss additive and an encapsulation material in an amount of about 0.1% to about 40% by weight of the encapsulated fluid-loss additive; wherein the fluid-loss additive is encapsulated by matrix encapsulation; and wherein the encapsulation material is selected to delay release of the fluid-loss additive into the cement composition for a time of from about 5 minutes to about 30 minutes;
mixing equipment capable of mixing the cement composition; and
pumping equipment capable of delivering the cement composition into a wellbore.

20. The cementing system of claim 19 wherein the fluid-loss additive comprises a water-soluble polymer selected from the group consisting of hydroxyethyl cellulose, carboxymethylhydroxyethyl cellulose, copolymers of 2-acrylamido-2-methylpropanesulfonic acid and acrylamide or N,N-dimethylacrylamide, graft copolymers comprising a backbone of lignin or lignite and pendant groups comprising at least one member selected from the group consisting of 2-acrylamido-2-methylpropanesulfonic acid, acrylonitrile, and N,N-dimethylacrylamide; xanthan gum, and any combinations thereof.

21. The cementing system of claim 19 wherein the encapsulation material is selected from the group consisting of paraffin wax, polyethylene wax, stearamide wax, and any combinations thereof.

22. (canceled)

23. A method of cementing comprising:
providing a cement composition comprising:
a hydraulic cement,
water, and
an encapsulated fluid-loss additive having a particle size from 20 about microns to about 100 microns; wherein the encapsulated fluid-loss additive comprises a fluid-loss additive in an amount of about 60% to about 99.9% by weight of the encapsulated fluid-loss additive and an encapsulation material in an amount of about 0.1% to about 40% by weight of the encapsulated fluid-loss additive; wherein the fluid-loss additive is encapsulated by matrix encapsulation;
placing the cement composition in a subterranean formation; and
allowing the cement composition to set;
wherein the encapsulation material delays release of the fluid-loss additive into the cement composition for a time of about 5 minutes to about 30 minutes.

24. The method of claim 23 wherein the cement composition has a density in a range of from about 4 pounds per gallon to about 20 pounds per gallon, and wherein the water is present in an amount sufficient to form a pumpable slurry.

25. The method of claim 23 wherein the hydraulic cement comprises at least one hydraulic cement selected from the group consisting of Portland cement, pozzolana cement, gypsum cement, high-alumina-content cement, slag cement, silica cement, and any combination thereof.

26. The method of claim 23 wherein the fluid-loss additive comprises a water-soluble polymer selected from the group consisting of hydroxyethyl cellulose, carboxymethylhydroxyethyl cellulose, copolymers of 2-acrylamido-2-methylpropanesulfonic acid and acrylamide or N,N-dimethylacrylamide, graft copolymers comprising a backbone of lignin or lignite and pendant groups comprising at least one member selected from the group consisting of 2-acrylamido-2-methylpropanesulfonic acid, acrylonitrile, and N,N-dimethylacrylamide; and any combination thereof.

27. The method of claim 23 wherein the encapsulated fluid-loss additive is present in the cement composition in an amount of about 0.1% to about 4% by weight of the cement composition.

28. The method of claim 23 wherein the encapsulation material is selected from the group consisting of paraffin wax, polyethylene wax, stearamide wax, and any combination thereof.

29. The method of claim 23 wherein the encapsulation material is present in the encapsulated fluid-loss additive in an amount of about 0.1% to about 20% by weight of the encapsulated fluid-loss additive.

30. The method of claim 23 wherein the fluid-loss additive is present in the encapsulated fluid-loss additive in an amount of about 80% to about 99.9% by weight of the encapsulated fluid-loss additive.

31. The method of claim 23 wherein the cement composition is used in a primary cementing operation.
